(19) United States
(12) Patent Application Publication
(10) Pub. No.: US 2019/0349216 A1
(43) Pub. Date: Nov. 14, 2019

(54) Method for monitoring a collection of barrels and associated apparatus

(71) Applicant: WID GROUP, BERNAY (FR)

(72) Inventors: Alexandre MONGRENIER, Manneville-Sur-Risle (FR); Benoît SUDRE, GIF SUR YVETTE (FR)

(21) Appl. No.: 16/482,643

(22) PCT Filed: Feb. 1, 2018
(86) PCT No.: PCT/EP2018/052492

§ 371 Date: Jul. 31, 2019

(30) Foreign Application Priority Data
Feb. 1, 2017 (FR) 17 50843

(51) Int. Cl. H04L 12/28; H04B 17/00

(52) U.S. Cl. CPC H04L 12/2825; B65D 9/04; H04L 2012/2841; H04B 17/00

(57) ABSTRACT

The invention concerns a method for monitoring a collection of barrels (12) by an apparatus for monitoring a collection of barrels (12) comprising:
for each barrel (12), at least one electronic module (18), the electronic module (18) being specific to the considered barrel (12), and
a user terminal,
the method including a step of:
for each barrel, recording first data in the associated electronic module (18),
collecting of second data by the user terminal operating in a second operating mode, and
transmitting the data to the data management platform.

The present invention relates to a method for monitoring a collection of barrels. The present invention also relates to an associated monitoring apparatus.

In the wine field, the maturation of a wine in a barrel is a crucial step requiring very significant know-how making it possible to guarantee a good quality for the obtained wine.

However, this know-how is a difficult know-how to transmit. Indeed, the maturation of the wine depends on multiple separate parameters, some of which depend on operations carried out on the barrel.

Furthermore, added to the multiple parameters to be monitored is the difficulty of the number of barrels to be monitored, this number being greater when the property is large.

There is therefore a need for a method for monitoring a collection of barrels making it possible to guarantee better sustainability in the monitoring of the content of each barrel in the collection, in particular the wine, without losing quality over the years.

To that end, the present description in particular relates to a method for monitoring a collection of barrels by an apparatus for monitoring a collection of barrels. The monitoring apparatus comprises, for each barrel, at least one electronic module specific to the considered barrel, the electronic module comprising a memory capable of storing data. The monitoring apparatus also includes a user terminal, the user terminal being a mobile terminal capable of operating according to a first operating mode and a second operating mode, the user terminal being able to communicate with a data management platform in the first operating mode and not communicating with the data management platform in the second operating mode, the user terminal further being provided with at least one wireless communication reader operating in both operating modes. The monitoring method includes, for each barrel, a step for recording first data in the associated electronic module, the first data being data relative to the barrel. The monitoring method also comprises a step for collecting second data by the user terminal operating in a second operating mode, the second data being data relative to the collection of barrels, and a step for transmitting the second data by the user terminal operating in the first operating mode to the data management platform.

According to specific embodiments, the monitoring method includes one or more of the following features, considered alone or according to any technically possible combinations:
the monitoring apparatus includes at least one sensor able to perform a measurement relative to the barrel and at least one datum from among the first data and the second data is a measurement coming from a sensor.
the method includes a step for carrying out a statistical analysis on the transmitted data, the analysis step being carried out by the data management platform.
in the collection step, at least a second datum is obtained by reading one of the first data.
in the collection step, at least a second datum is separate from the first data.
the second data comprise the first data and additional data.
the method further includes a step for determining the barrel whose content is to be tasted including the calculation, for each barrel, of a tasting score of the content of the barrel as a function of the transmitted data.
the method further includes a step for comparing transmitted data to reference data and an alert step when transmitted data are missing or when transmitted data are too far from reference data.
at least one datum from among the first data and the second data is a datum relative to the ageing of the content of a barrel, the winemaking process of the content of a barrel, or the development of the content of a barrel, for example a datum relative to the sulfiting, the packing, the ullage or the clarifying of the content of a barrel.
at least one barrel includes maintaining hoops, the electronic module specific to said at least one barrel being located on a hoop of said at least one barrel.
for each barrel, the barrel includes maintaining hoops, the electronic module specific to the barrel being located on a hoop of the considered barrel.
each hoop includes posts delimiting spaces, a space being located between two posts, the electronic module being affixed on the space.
the collection step is implemented by an operator.
the electronic module is made according to two separate communication protocols, the first protocol being a radiofrequency identification protocol, the second protocol being a communication protocol in close communication or an Ultra-High Frequency protocol.
at least one barrel comprises a wall having an inner face and an outer face, the wall defining an inner volume of said barrel comprised between the inner face and the outer face, the electronic module of said at least one barrel being located in the inner volume of said at least one barrel.
each barrel comprises a wall having an inner face and an outer face, the wall defining an inner volume of the considered barrel comprised between the inner face and the outer face, the electronic module of the considered barrel being located in the inner volume of the considered barrel.
at least one barrel comprises a wall having an inner face and an outer face, the wall defining an inner volume of said barrel comprised between the inner face and the outer face, a first electronic module being located in the inner volume comprised between the inner face and the outer face of the barrel and a second electronic module being affixed on the outer face of the barrel.
the number of barrels of the collection of barrels is greater than or equal to 10 barrels.
the number of barrels of the collection of barrels is greater than or equal to 50 barrels.
the number of barrels of the collection of barrels is greater than or equal to 100 barrels.
the content of each barrel is a food product.
the content of each barrel is a liquid product.
the content of each barrel is an alcoholic beverage.
at least one datum from among the first data and the second data is a measurement done on the barrel or on the content of the barrel, in particular a measurement relative to the pressure, the temperature or the dioxygen concentration of the content of the barrel.
the user terminal reads data coming from other markers.
during the collection step, the user terminal reads data relative to elements necessary to develop the content of the barrel, in particular gas, proteins or inputs.
at least one datum from among the first data and the second data is a datum relative to the lot number of the content of a barrel, the method furthermore including a step for determining barrels comprising a content with the same lot number.

The present description also describes an apparatus for monitoring a collection of barrels, the monitoring apparatus comprising, for each barrel, at least one electronic module specific to the considered barrel, the electronic module comprising a memory capable of storing first data, the first data being data relative to the barrel. The monitoring apparatus also includes a user terminal, the user terminal being a mobile terminal capable of operating according to a first operating mode and a second operating mode, the user terminal being able to communicate with a data management platform in the first operating mode and not communicating with the data management platform in the second operating mode, the user terminal further being provided with at least one wireless communication reader operating in both operating modes, the user terminal being able to collect second data in the second operating mode, the second data being data relative to the collection of barrels, and to send the second data by the user terminal operating in the second operating mode to the data management platform.

According to specific embodiments, the monitoring apparatus includes one or more of the following features, considered alone or according to any technically possible combinations:
the monitoring apparatus includes at least one sensor able to perform a measurement relative to the barrel and at least one datum from among the first data and the second data is a measurement coming from a sensor.
the monitoring apparatus is able to carry out a monitoring method as previously described.
the monitoring apparatus includes a data management platform including a module for carrying out a statistical analysis on data.
at least a second datum is separate from the first data.
the second data comprise the first data and additional data.
the monitoring apparatus includes a data management platform that includes a module for determining the barrel whose content is to be tasted including the calculation, for each barrel, of a tasting score of the content of the barrel as a function of the transmitted data.
the monitoring apparatus includes a data management platform that includes a module for comparing transmitted data to reference data and an alert step when transmitted data are missing or when transmitted data are too far from reference data.
at least one datum from among the first data and the second data is a datum relative to the ageing of the content of a barrel, the winemaking process of the content of a barrel, or the development of the content of a barrel, for example a datum relative to the sulfiting, the packing, the ullage or the clarifying of the content of a barrel.
at least one barrel includes maintaining hoops, the electronic module specific to said at least one barrel being located on a hoop of said at least one barrel.
for each barrel, the barrel includes maintaining hoops, the electronic module specific to the barrel being located on a hoop of the considered barrel.
each hoop includes posts delimiting spaces, a space being located between two posts, the electronic module being affixed on the space.
the electronic module is made according to two separate communication protocols, the first protocol being a radiofrequency identification protocol, the second protocol being a communication protocol in close communication or an Ultra-High Frequency protocol.
at least one barrel comprises a wall having an inner face and an outer face, the wall defining an inner volume of said barrel comprised between the inner face and the outer face, the electronic module of said at least one barrel being located in the inner volume of said at least one barrel.
each barrel comprises a wall having an inner face and an outer face, the wall defining an inner volume of the considered barrel comprised between the inner face and the outer face, the electronic module of the considered barrel being located in the inner volume of the considered barrel.
at least one barrel comprises a wall having an inner face and an outer face, the wall defining an inner volume of said barrel comprised between the inner face and the outer face, a first electronic module being located in the inner volume comprised between the inner face and the outer face of the barrel and a second electronic module being affixed on the outer face of the barrel.
the number of barrels of the collection of barrels is greater than or equal to 10 barrels.
the number of barrels of the collection of barrels is greater than or equal to 50 barrels.
the number of barrels of the collection of barrels is greater than or equal to 100 barrels.
the content of each barrel is a food product.
the content of each barrel is a liquid product.
the content of each barrel is an alcoholic beverage.
at least one datum from among the first data and the second data is a measurement done on the barrel or on the content of the barrel, in particular a measurement relative to the pressure, the temperature or the dioxygen concentration of the content of the barrel.
the user terminal reads data coming from other markers.
at least one datum from among the first data and the second data is a datum relative to the lot number of the content of a barrel, the method furthermore including a step for determining barrels comprising a content with the same lot number.

Other features and advantages of the invention will appear upon reading the following description of embodiments of the invention, provided as an example only and in reference to the drawings, which are:

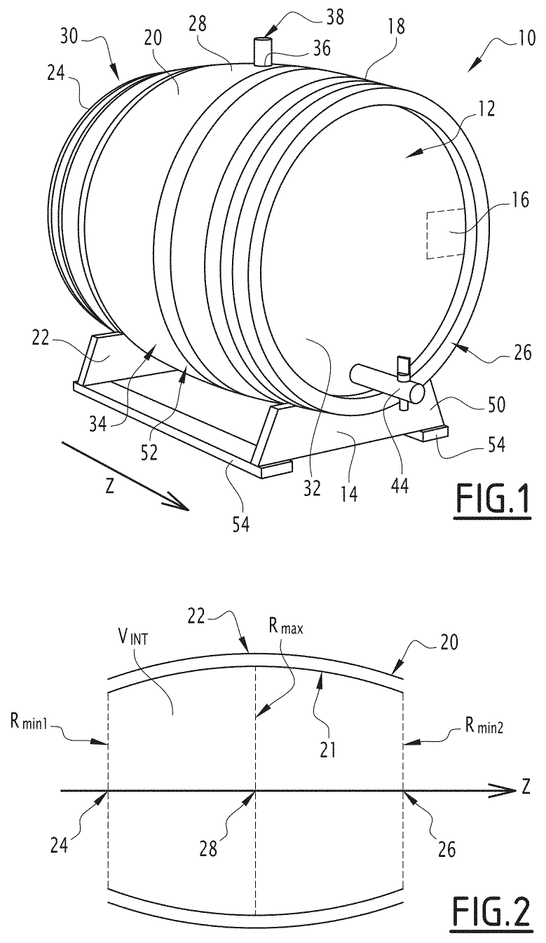

FIG. 1, a perspective view of an example of part of an apparatus for monitoring a collection of barrels,

FIG. 2, a side view of the barrel of FIG. 1 in section,

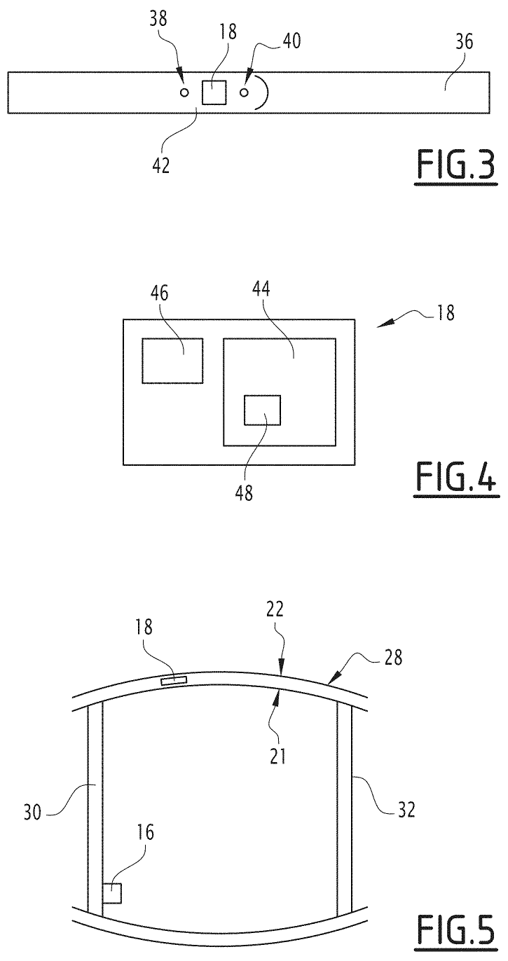

FIG. 3, a schematic view of a hoop of the barrel of FIG. 1, the hoop being provided with an electronic module,

FIG. 4, a schematic illustration of the module of FIG. 3, and

FIG. 5, a schematic view of part of another example monitoring apparatus.

An apparatus 10 for monitoring a collection of barrels 12 is shown in FIG. 1.

The monitoring apparatus 10 is able to provide the monitoring of a plurality of barrels 12 forming the collection.

For example, the collection of barrels 12 includes more than 10 barrels.

According to another example, the collection of barrels 12 comprises at least 50 barrels 12.

Preferably, the collection of barrels 12 includes more than 100 barrels 12.

Monitoring means that the monitoring apparatus 10 is able to monitor the evolution over time of at least one parameter relative to the barrel 12 or to the content of the barrel 12.

The monitoring apparatus 10 includes, for each barrel 12 of the collection, a part installed on the barrel 12 and a user terminal.

For simplification, only part of the monitoring apparatus 10 is shown in FIG. 1, the visible part being the part installed on a barrel 12. The other barrels 12 of the collection are equipped similarly with an identical installed part.

The barrel 12 present in FIG. 1 is a barrel of liquid. The barrel 12 is placed on a support 14.

The installed part of the monitoring apparatus 10 is the barrel 12 equipped with an electronic module 18.

In the described example, the installed part of the monitoring apparatus 10 is the barrel 12 equipped with a sensor 16 and an electronic module 18.

In a variant, the installed part of the monitoring apparatus 10 includes elements making it possible to provide monitoring of the barrel 12 that are positioned outside the barrel 12. “Positioned outside” means outside the inner volume of the barrel 12 and not positioned on a surface of the barrel 12. In such an example, the barrel 12 is not part of the installed part of the monitoring apparatus 10.

For example, the electronic module 18 is positioned on a display, the display being next to the barrel 12.

Similarly, in one example, the sensor 16 is positioned outside the barrel 12 and is therefore not part of it. This is, for example, the case of a sensor 16 able to measure the temperature outside the barrel 12.

Furthermore, it should be noted that the sensor 16 can, in some cases, be shared by several barrels 12. For example, a temperature sensor positioned equidistantly from two barrels 12 is able to measure the outside temperature of each of the barrels 12. The temperature sensor is thus specific to each barrel 12.

In general, the installed part of the monitoring apparatus 10 groups together the elements making it possible to provide monitoring of the barrel, i.e., at least a sensor 16 and an electronic module 18.

In the specific described case, the installed part of the monitoring apparatus 10 also includes the barrel 12, since the sensor 16 and the electronic module 18 are part of the barrel 12.

“Barrel” refers to any container including staves. For example, a keg, a quartaut, a cask, a tank, a jar or a tun are considered in the context of the present description to be barrels.

The barrel 12 includes a wall 20 having an inner face 21 and an outer face 22.

The inner face 21 is a closed surface such that the inner face 21 delimits an inner volume Vᵢₙₜ of the barrel 12.

The barrel 12 isolates the inner volume Vᵢₙₜ from the outside of the barrel 12.

The inner volume Vᵢₙₜ is intended to receive the content of the barrel 12.

According to the described example, the inner volume Vᵢₙₜ is intended to receive an alcoholic beverage.

In the case at hand, the inner volume Vᵢₙₜ contains wine.

According to other examples, the inner volume Vᵢₙₜ includes a spirit or juices.

In all cases, the inner volume Vᵢₙₜ includes a beverage, such that the barrel 12 is a beverage barrel.

The inner volume Vᵢₙₜ has a capacity that can be expressed in particular in liters. The capacity of the inner volume is the capacity of the barrel.

For example, the capacity is comprised between 1 liter and 1500 liters.

The expression “comprised” is to be understood broadly. Thus, a property A is comprised between a first value A1 and a second value A2 when, on the one hand, the property A is greater than or equal to the first value A1 and, on the other hand, the property A is less than or equal to the second value A2.

According to one example, the capacity is comprised between 100 liters and 600 liters, preferably between 100 liters and 400 liters.

According to the described example, the barrel 12 has a capacity of 228 liters.

According to other embodiments, the content of the barrel 12 is a food product, preferably in liquid form.

The outer face 22 of the wall 20 gives a shape to the barrel 12.

The barrel 12 has an axis of symmetry making it possible to define a longitudinal direction. The longitudinal direction is symbolized by an axis Z in FIG. 1. The longitudinal direction is thus denoted longitudinal direction Z in the remainder of the description.

The barrel 12 extends along the longitudinal direction Z between a first end 24 and a second end 26.

The distance between the first end 24 and the second end 26 of the barrel 12 defines the length of the barrel 12.

The length of the barrel 12 is several meters.

In each plane perpendicular to the longitudinal direction Z, the section of the barrel 12 has the same geometric shape.

According to the example of FIG. 1, the geometric shape is a disc for which a radius is defined.

As shown in FIG. 2, when the sections of the barrel 12 are traveled from the first end 24 toward the second end 26, the radius of the section increases from a first minimum radius Rₘᵢₙ₁ up to a maximum radius Rₘₐₓ, then decreases to a second minimum radius Rₘᵢₙ₂.

The first minimum radius Rₘᵢₙ₁ is equal to the second minimum radius Rₘᵢₙ₂. The equality Rₘᵢₙ₁=Rₘᵢₙ₂ is therefore verified for the barrel 12 of FIG. 1. Hereinafter, to designate this value, the expression minimum radius Rₘᵢₙ is used.

In such a configuration, the maximum radius Rₘₐₓ is reached a point corresponding to the center 27 of the barrel 12.

The ratio between the minimum radius Rₘᵢₙ and the maximum radius Rₘₐₓ is greater than 80% such that the barrel 12 has a slightly curved cylindrical shape at the center 27.

The wall of the barrel 12 includes three parts: a lateral part 28 and two bottoms 30 and 32.

The lateral part 28 is formed by two staves 34 assembled by hoops 36.

The staves 34 are boards.

The staves 34 extend between the first end 24 of the barrel 12 and the second end 26 of the barrel 12.

The staves 34 are for example made from wood.

According to another example, the staves 34 are made from plastic, ceramic or stainless steel.

A stave 34 delimits a bung hole.

The bung hole is a through hole intended to be plugged by a bung 38. The bung 38 is visible in FIG. 1.

The bung hole allows an operator to monitor the content of the barrel 12.

Each hoop 36 is a maintaining hoop. The hoops 36 provide the assembly and maintenance of the staves 34 in position.

Each hoop 36 is positioned parallel to the bottoms 30 and 32, i.e., perpendicular to the longitudinal direction Z.

Each hoop 36 is made from metal.

Each hoop 36 has an annular shape.

The annular shape is specific, since the radius of the disc delimited by the hoop 36 evolves monotonously along the longitudinal direction Z.

The annular shape extends along the longitudinal direction Z between a first end and a second end. The distance between the two ends along the longitudinal direction Z is called length of the hoop 36.

The length of the hoop 36 is comprised between 3 centimeters and 7 centimeters.

Each hoop 36 has a complete annular shape. This means that the hoop 36 surrounds the staves 34 continuously.

To that end, the hoops 36 are fastened to the staves 34, for example by threaded fasteners.

The threaded fasteners are hidden by posts 38 and 40.

As shown in particular in FIG. 3, each hoop 36 includes posts 38 and 40 located at a distance of several centimeters.

The posts 38 and 40 delimit two spaces on the hoop 36. The smallest space is identified by reference sign 42 for the remainder of the present application.

In the example shown in FIG. 1, the barrel 12 includes six separate hoops 36.

The six hoops 36 are positioned symmetrically relative to the center of the barrel 12.

In a variant, the number of hoops 36 is different.

For example, the number of hoops is equal to four or eight.

In general, the number of hoops is even to allow symmetrical positioning of the hoops 36 relative to the center of the barrel 12.

In a variant, the barrel 12 has no hoops 36. This is for example the case when the staves 34 are made from stainless steel.

Each bottom 30 and 32 is a disc of equal radius.

The first bottom 30 is close to the first end 24 of the barrel 12. More specifically, the first bottom 30 is in a recess of the side wall 20.

Similarly, the second bottom 32 is close to the second end 26 of the barrel 12. More specifically, the second bottom 32 is in a recess of the side wall 20.

In the described example, the bottoms 30 and 32 are symmetrical relative to a plane normal to the longitudinal direction Z and passing through the center 27 of the barrel 12.

According to the described example, the first bottom 30 includes a tap 44.

The tap 44 is movable between an open position and a closed position.

In the open position, the tap 44 allows the flow of the liquid contained in the barrel 12.

In the closed position, the barrel 12 is closed and no flow of liquid is possible.

The tap 44 is sometimes also called spigot or drain valve.

In a variant, each bottom 30 and 32 is provided with a tap 44.

The sensor 16 is a sensor able to measure a parameter relative to the barrel 12 or to the content of the barrel 12, in the case at hand, wine.

For example, the sensor 16 is fastened to the bung 38. When the bung 38 plugs the bung hole, the sensor 16 is in the inner volume Vᵢₙₜ.

For example, the measured parameter is the pressure. The sensor 16 is then a pressure sensor.

In a variant or additionally, the parameter that the sensor 16 is able to measure is the turbidity of the alcoholic beverage in the barrel 12, the temperature, the color, the level of alcoholic beverage in the barrel 12, the acidity, the pH, the dioxygen concentration of the alcoholic beverage in the barrel 12, the quantity by volume of sugar or the quantity by volume of alcohol.

As illustrated by FIG. 4, the electronic module 18 comprises an electronic chip 44 and an antenna 46.

The electronic chip 44 has an area smaller than 1 mm² such that the electronic chip is often described as “electronic microchip”.

The electronic chip 44 includes a memory 48 able to store data.

The data are data specific to the barrel 12 (whether the barrel 12 itself or the content of the barrel 12).

For this reason, the electronic module 18 is a module “specific to the barrel 12”.

The name of the cooper of the barrel 12, the manufacturing year of the barrel 12, the type of heating, the type of wood of the barrel 12, the volume of the barrel 12, the manufacturing reference assigned to the barrel 12, the date of entry into inventory, the reference assigned to the barrel 12 upon entering the collection of barrels 12, the status of the barrel 12 are examples of data specific to the barrel 12.

The status of the barrel 12 corresponds to the orientation of the bung hole of the barrel 12 when the barrel 12 is positioned on the support 14.

For example, the barrel 12 is oriented such that the bung hole is not in contact with the content of the barrel 12. This makes it possible to accelerate the oxygenation of the content of the barrel 12.

Also for example, the barrel is oriented such that the bung hole is in contact with the content of the barrel 12. This makes it possible to slow the oxygenation of the content of the barrel 12.

The lot number of the content of the barrel 12 is another example of data specific to the barrel 12.

In the described example, the color of the wine contained in the barrel 12, the vintage of the wine contained in the barrel 12 are also examples of data specific to the barrel 12.

The operation(s) implemented on the barrel 12 are other examples of data specific to the barrel 12. Ullage, bottling, clarifying or transfer are specific illustrations of such operations.

The antenna 46 makes it possible to exchange signals according to a protocol called “first protocol”.

The first protocol is for example according to standards ISO14443 (NFC protocol) or ISO15693 (RFID protocol). The communication range according to the first protocol is preferably less than 50 centimeters (cm).

The antenna 46 has a surface corresponding to several mm².

The electronic module 18 is located on a hoop 36.

According to the example of FIG. 1, the electronic module 18 is affixed on the smallest space 42 of a hoop 36.

Advantageously, the electronic module 18 then has a round shape.

The support 14 includes two support parts 50 and 52 connected by two reinforcements 54.

The support parts 50 and 52 extend primarily along a plane normal to the longitudinal direction Z while the reinforcements 54 extend primarily along the longitudinal direction Z.

Each support part 50 and 52 is positioned between two hoops 36 of the barrel 12.

As previously explained, the monitoring apparatus 10 includes, for each barrel 12, at least one sensor 16 capable of performing a measurement relative to the barrel 12 and an electronic module 18, the electronic module 18 being specific to the considered barrel 12 and comprising a memory 48 able to record data.

For example, the memory 48 is able to record data in clear and encrypted data.

The data in clear are accessible by any reader able to communicate with the electronic module 18. The encrypted data are accessible by a reader able to communicate with the electronic module 18 using a decryption key.

This makes it possible to guarantee the security of the data recorded in the memory 48.

The monitoring apparatus 10 further includes a user terminal.

The user terminal is for example a personal digital assistant (PDA).

The user terminal is comparable to a processing module.

The user terminal comprises processing software stored in a memory, a processor on which the processing software can be executed, and a man/machine interface comprising a screen according to the illustrated case.

In a variant, the man/machine interface includes a screen and a keyboard.

In each case, the user terminal is a mobile terminal.

The user terminal is able to operate according to a first operating mode and a second operating mode.

The user terminal is able to communicate with a data management platform in the first operating mode. For this reason, the first operating mode is sometimes called “ONLINE mode” (also called “connected” mode).

The data management platform is for example a computer on which a data management program is implemented.

According to the proposed example, the data management program is a website using the transmitted data. In this case, the data management platform is described as “web platform”. This makes it possible to access the data management platform from any location.

The communication is in particular implemented via a communication network.

For example, the communication network is a wireless site, of the Wi-Fi type.

The user terminal is not able to communicate with a data management platform in the second operating mode. For this reason, the first operating mode is sometimes called “OFFLINE mode” (also called “disconnected” mode). The user terminal is further provided with at least one wireless communication reader operating in both operating modes.

In the described example, the user terminal includes a reader according to the first protocol and at least one from among a bar code reader, a Datamatrix® code reader or a QR code reader.

According to one variant, the monitoring apparatus 10 includes a maintenance booklet of the barrel 12.

The maintenance booklet for example assumes a paper format or digital format usable by the user terminal.

The maintenance booklet comprises information relative to the maintenance of the barrel 12 during its stay in the collection of barrels 12.

In a variant or additionally, the maintenance booklet comprises information relative to the maintenance of the barrel 12 during its manufacturing.

The maintenance booklet is kept by an operator responsible for noting each maintenance operation performed on the barrel 12.

Washing, the passage of steam and drying are specific examples of maintenance operations.

In a variant or additionally, the maintenance booklet comprises information relative to the laboratory analyses of the barrel 12 or the content of the barrel 12.

The maintenance booklet guarantees the quality of the barrel 12, for example in case of resale of the barrel 12.

According to another variant, the monitoring apparatus 10 includes one worksheet per operator for the collection of barrels 12.

The worksheet is specific to each operator.

The worksheet for example assumes a paper format or digital format usable by the user terminal.

The worksheet of an operator for example comprises information relative to the maintenance operations of the barrels 12, or operations implemented on the barrel 12 done by the operator.

The date of the operation, the nature of the operation, the duration of the operation or the scheduled date for the next operation are specific examples of information relative to the operations done by the operator.

This makes it possible to reliabilize the operations performed for each barrel 12 as well as to avoid forgetting an operation to be performed.

According to one variant, the monitoring apparatus 10 includes a tasting booklet.

The tasting booklet comprises information relative to the tasting of the content of the barrel 12.

The tasting booklet for example assumes a paper format or digital format usable by the user terminal.

The tasting booklet is kept by an operator tasting the content of the barrel 12.

The color, the nose, the flavors and the aromas are specific examples of information relative to the tasting of the content of the barrel 12.

The tasting booklet guarantees the quality of the content of the barrel 12.

The operation of the monitoring apparatus 10 is now described in reference to an example embodiment of a method for monitoring a collection of barrels 12.

It is assumed that a collection of barrels 12 and a monitoring apparatus 10 are provided as described in reference to FIGS. 1 to 4.

In a variant, a collection of barrels 12 is provided. The collection of barrels 12 is then equipped with the monitoring apparatus 10.

The monitoring method includes, for each barrel 12, a step for recording first data in the memory 48 of the electronic module 18.

The first data are relative to the considered barrel 12.

This means that each memory 48 of each electronic module 18 includes data relative to the barrel 12 whose electronic module 18 is specific.

In the described example, each memory 48 includes the same data.

In particular, each memory 48 stores the evolution over time of at least one parameter relative to the barrel 12 or to the content of the barrel 12.

In the proposed example, each memory 48 stores the evolution over time of the pressure in the inner volume Vᵢₙₜ.

The monitoring method also comprises a step for collecting second data by the user terminal operating in a second operating mode.

The second data are relative to the collection of barrels 12.

Data relative to a barrel 12 of the collection are data relative to the collection of barrels 12.

In the proposed example, the second data are a set of data grouping together the first data and additional data.

The collection of the first data by the user terminal is implemented by reading first data in each memory.

The second data therefore include the evolution over time of the pressure in the inner volume Vᵢₙₜ of each barrel 12.

The additional data are obtained by an operator holding the user terminal. For example, the operator enters the data in the user terminal.

In a variant, the user terminal reads the data coming from other elements or another marker such as barcodes, Datamatrix® codes, QR codes, stamps or etchings.

For example, the user terminal reads data relative to elements necessary to develop the content of the barrel 12.

The elements necessary to develop the content of the barrel for example comprise gas, proteins or inputs added into the content of the barrel 12.

An input is a product that is not naturally present in the wine and that is added during winemaking. For example, the input is citric acid or sulfurous anhydride.

The monitoring method also comprises a step for data transmission by the user terminal to the management platform.

The transmission of the second data is carried out when the user terminal operates in the first operating mode.

The transmission is for example done through the local wireless network.

To that end, the user terminal rests on a base providing the switching of the user terminal from the second operating mode to the first operating mode.

Such a method makes it possible to provide monitoring of the evolution of the content of the barrels 12 using a dedicated monitoring apparatus 10, in particular by using the data management platform.

The method therefore makes it possible to provide monitoring of the content of each barrel 12 without interacting with the content. This improves the traceability of the content of each barrel 12. This also improves the inventory of the content of each barrel 12.

In particular, the monitoring method makes it possible to guarantee better sustainability in the monitoring of the content of each barrel 12 without losing quality over the years.

As a result, the use of first and second data makes it possible to guarantee the quality of the wine contained in the barrels, without error, by monitoring the evolution over time of at least one parameter coming from a sensor 16.

It is understood that the use of first and second data also makes it possible to guarantee the quality of the wine contained in the barrels, without error, by monitoring the evolution over time of at least one parameter when this parameter does not come from a sensor 16.

The monitoring method also improves the overall traceability of the collection of barrels 12. This also improves the inventory of the collection of barrels 12. Other embodiments of the monitoring method can be considered.

For example, according to one specific embodiment, the first data are transmitted to the management platform without going through the user terminal. For example, the first data are read by an operator, then recorded in the management platform.

In a variant, the first data are transmitted to the management platform without going through the user terminal and going through the user terminal to ensure redundancy of the information.

According to one particular embodiment, one of the transmitted data is a datum relative to sulfiting.

Sulfiting is an operation consisting of adding a quantity of sulfurous anhydride (SO₂) to the grape must or to the wine to allow good winemaking and to favor good conservation.

For example, the sulfiting datum is information on the quantity of sulfurous anhydride introduced into the content of the barrel 12.

According to another example, the information relative to the sulfiting is information relative to the date(s) on which the sulfurous anhydride was introduced into the content of the barrel 12.

Preferably, a datum relative to the sulfiting of each barrel 12 is present in the first data or the second data.

According to another example, the transmitted data are data coming from a plurality of sensors 16.

In particular, the transmitted data are temperature data of the content and pressure data of the content of each barrel 12.

According to another example, the transmitted data are data relative to the dioxygen content of the alcoholic beverage in each barrel 12.

According to more evolved examples, the monitoring method includes additional steps.

For example, the method includes a step for carrying out a statistical analysis on the transmitted data, the analysis step being carried out by the data management platform.

For example, the statistical analysis step comprises a step for comparing several barrels 12 to one another by comparison of the evolution over time of one or several parameters measured by the sensor 16 of each barrel 12.

This makes it possible to determine the influence of given factors, for example the nature of the wood of the barrel 12 or the manufacturing method of the barrel 12, on the content of each barrel 12.

Also for example, the statistical analysis step comprises providing results obtained from transmitted data and exporting the results in a file.

A spreadsheet, a PDF file or a file in Print format are specific examples of files for exporting results.

This makes it possible to publish reports at any moment.

At the end of maturation, it is common to implement partial bottling of the content of the barrel 12. The barrel 12 is emptied to a non-nil residual content level of the barrel 12.

The statistical analysis step for example comprises a step for calculating the residual level of the content of the barrel 12 after partial bottling.

According to one example, the data monitoring method includes interfacing with ageing monitoring software for the content of the barrel 12.

According to another example, the method includes a step for determining the barrel whose content is to be tasted by calculating, for each barrel 12, a tasting score of the content of the barrel 12 as a function of the data.

As an illustration, the barrel 12 whose content has the highest pressure while being below a threshold value is selected to be tasted by a potential client. This makes it possible to have the potential client taste, during a visit to the collection of barrels 12, content already having a good gustatory value.

The function actually employed will depend on the know-how of the people responsible for the maturation of the content of the barrels.

According to another example, the method further includes a step for determining barrels 12 comprising content with a same lot number.

This makes it possible to apply operations to several barrels having a content with a same lot number.

According to another example, the monitoring method includes a step for selecting barrels 12 needing one or several operations per operator.

The operator enters a selection criterion into the user terminal, for example a lot number of one or several barrels 12, the lot number of the content of one or several barrels 12, the cooper of origin for one or several barrels 12.

The user terminal identifies the selected barrel(s) and sends the information back to the operator.

This makes it possible to apply operations to one or several barrels according to a criterion chosen by the user, and to save time during entry operations.

According to another example, the monitoring method includes a step for comparing transmitted data relative to a barrel 12 to reference data for a barrel 12 and an alert step when transmitted data are missing or when data are too far from reference data.

The reference data are for example stored in the management platform.

If no data transmitted on sulfiting is present for a barrel 12, this can mean that the operation for the considered barrel 12 has not been implemented or that the data relative to the operation has not been collected or noted.

The expression “too far” means that the distance in value between the transmitted data and the reference data is strictly above a threshold value.

Preferably, the threshold value is configurable, in particular from the management platform.

For example, if the pressure of the inner volume V_{INT} is too low, this can mean that a hole is present in the barrel 12 and that the hole should be plugged so as not to damage the quality of the content of the barrel 12.

The data monitoring method is able to implement a maintenance request of the barrel 12 online.

An operator is warned of a problem, and can make a maintenance request online using the data management program. A maintenance number is assigned to the maintenance request.

According to another example, the online maintenance request is made by an operator after the identification of a problem by the operator.

According to another example, if the level of alcoholic beverage contained in the barrel 12 is too low, this means that an ullage operation should be performed in the barrel 12.

According to one variant, the method includes writing first data in each memory 48 using the user terminal.

For example, this makes it possible to migrate data present in the form of stamps, etchings, barcodes, Datamatrix® codes or QR codes into each memory 48.

This also makes it possible to write, in each memory 48, first data that are not measurable by a sensor 16, for example the cooper of origin of the barrel 12, with a lot number of the content of the barrel 12.

The first data for example include a serial number of the barrel 12, in particular a serial number etched on a part of the barrel 12. For example, the serial number is etched on a hoop 36.

In winemaking, it is common to make several wines contained in separate first barrels 12 from the collection of barrels 12 and to decant them into a same second barrel 12 separate from the first barrels 12.

In this case, the writing of the first data in each memory 48 using the user terminal for example comprises writing first data relative to the contents of the first barrels 12 in the memory 48 of the electronic module 18 of the second barrel 12.

In particular, the proportion of each content of the first barrels 12, the lot numbers of the contents of the first barrels 12, the color of the wines contained in the first barrels 12, the vintages of the wines contained in the first barrels 12, the residence time of the contents of the first barrels 12, the references assigned to the first barrels 12 upon entering the collection of barrels 12, are specific examples of first data written in the memory 48 of the electronic module 18 of the second barrel 12.

This allows improved traceability of each barrel 12 and the content of each barrel 12 of the collection of barrels 12, all throughout the maturation of the content of the barrels 12. This also improves the inventory of each barrel 12 and the content of each barrel 12.

As an illustration, if a contaminated barrel is detected, it is possible to identify all of the liquids having been contained in the barrel, and to eliminate them to guarantee sanitary safety.

According to one embodiment, the access to the user terminal or the data management platform assumes identification of an authorized user.

For example, access is encoded by passwords.

In a variant, the user terminal is used to scan a badge, the user only being able to access the user terminal if the badge is authenticated.

According to another embodiment, access assumes entering a password and authenticating a scanned badge.

It is further advantageous for the person(s) having access to the user terminal to be different from the person(s) having access to the data management platform.

In a variant, the accesses of these persons are differentiated. For example, the person(s) having access to the user terminal in write mode and in read mode only have access in read mode to the data management platform.

In addition, the person(s) having access to the data management platform in write mode and in read mode only have access to the user terminal in read mode.

The monitoring method can relate to several different types of data.

One specific example is described more precisely hereinafter.

The data include data relative to the containers such as the cooper of origin of the barrel 12, the volume of the barrel 12 or the type of heating.

The data further include data relative to the operations carried out on the barrel 12 when empty.

Among these operations, the receipt, preparation, addition of wine, rinsing, scalding, packing, status or repair are specific examples.

The data further include data relative to the operations carried out on the barrel 12 once filled.

Among these operations, the placement, tasting, ullage, bottling, clarifying, transfer, sulfiting or emptying are specific examples.

The data further include data relative to the content of the barrel 12.

Among these data, the lot number of the content of the barrel 12, the color of the wine contained in the barrel 12, the vintage of the wine contained in the barrel 12 are specific examples.

As previously explained, the preceding data are either first data, or second data, each of these data being transmitted to the data management platform.

According to another embodiment, the position of each electronic module 18 is specific.

According to the example of FIG. 5, the wall 20 defines an inner volume comprised between the inner face 21 and the outer face 22.

The electronic module 18 is located in the inner volume.

For example, the electronic module 18 is in a stave 34 or in a bottom 30 or 32.

The integration of an electronic module 18 into the wall of the barrel 12 makes it possible to guarantee an integrity of the electronic module 18 and information that the electronic module 18 contains, and does not make the electronic module 18 easily accessible.

Other locations of the electronic module 18 are possible.

For example, the electronic module 18 is affixed on the outer face of a bottom of the barrel 12.

According to a variant, a first electronic module 18 is located in the inner volume comprised between the inner face 21 and the outer face 22 of the barrel 12 and a second electronic module 18 is affixed on the outer face 21 of the barrel 12.

According to other examples that are not shown, the barrel 12 has forms other than the form of the barrels of FIGS. 1 to 5. For example, the barrel 12 has a frustoconical or parallelepiped shape.

Other embodiments can also be considered for the monitoring apparatus 10.

In particular, the electronic modules 18 can be of different types.

Thus, the electronic modules correspond to all of the electronic devices (integrated circuits) making it possible to store at least one piece of information and to communicate with another device according to a contactless communication protocol.

According to another embodiment, the electronic module 18 is an NFC (Near Field Communication) module, allowing near-field reading (with a maximum distance of about 4 cm between the electronic module 18 and the electronic chip reader).

The communication protocol is then a near field communication protocol of the NFC type defined according to the standards recognized by the NFC Forum, including standards ISO/CEI 14443-1 to ISO/CEI 14443/4.

It should be noted that the NFC standard is a wireless communication standard (called near field communication or NFC communication) making it possible for the electronic communication modules to communicate with a very large number of apparatuses, in particular wireless mobile telephones. This makes it possible to trace the barrel 12 and the content of the barrel 12.

According to one particular case, the electronic module 18 is able to operate according to two separate frequency ranges. In this sense, the electronic module 1 can be described as dual-frequency module.

On the one hand, the electronic module 18 is able to communicate according to a first communication mode called UHF mode. The acronym “UHF” stands for ultrahigh frequency.

In such a communication protocol, the electronic module 18 is able to transmit or receive a signal having a frequency of between 300 MHz and 3000 MHz.

According to one example, the monitoring apparatus 10 comprises a reinforced wireless communication reader able to communicate according to the UHF mode.

An RFID racket or an RFID gun are specific examples of reinforced wireless communication readers.

Such a reader is able to detect a plurality of electronic modules 18 communicating according to the UHF mode.

Preferably, the reinforced wireless communication reader is able to communicate with the data management platform to transmit the read data.

This makes it possible to take an inventory of the barrels 12 from the collection of barrels 12.

In a variant or in addition to this example, the monitoring method comprises a step for locating barrels 12 in the collection of barrels 12.

In this case, the monitoring method is also able to locate barrels. For example, the monitoring method includes a step for recording the position of each barrel 12 in a central memory (for example in the server) and in the memory 48 of the respective electronic module 18 of each barrel 12.

The step for recording the position of each barrel 12 is for example carried out after reading the set of memories 48 of the respective electronic modules 18 of each barrel 12 by a reinforced wireless communication reader able to communicate according to the UHF mode.

According to this example, a user of the data management platform enters at least one datum from among the first data or the second data relative to the barrel 12 or the barrels 12 that are sought.

The monitoring method then includes a step for processing the entered datum or data.

The monitoring method then includes a step for sending information comprising the position of the barrel 12 or barrels 12 that are sought.

The information is for example a command to illuminate a light located over the sought barrel 12 or barrels 12 in the collection of barrels 12.

In a variant or additionally, the information is to be displayed on the user terminal.

This makes it possible to display a map of the barrels, and to monitor their locations and movements in the collection of barrels 12 at any moment.

Furthermore, the electronic module 18 is able to communicate according to a second communication protocol called HF mode. The acronym “HF” stands for high frequency.

In such a protocol, the electronic module 18 is able to transmit or receive a signal having a frequency of between 3 MHz and 30 MHz.

Such an electronic module 18 is difficult to imitate, and allows monitoring and effective traceability. Such an electronic module 18 also allows effective inventory.

Furthermore, such an electronic module 18 makes it possible to communicate with a very large number of apparatuses.

The invention corresponds to any technically possible combination of the embodiments previously described.

1. A method for monitoring a collection of barrels by an apparatus for monitoring a collection of barrels, the monitoring apparatus comprising:
for each barrel, at least one electronic module, the electronic module being specific to the considered barrel and comprising a memory capable of storing data, and
a user terminal, the user terminal being a mobile terminal capable of operating according to a first operating mode and a second operating mode, the user terminal being able to communicate with a data management platform in the first operating mode and not communicating with the data management platform in the second operating mode, the user terminal further being provided with at least one wireless communication reader operating in both operating modes,
the method including a step of:
for each barrel, recording first data in the associated electronic module, the first data being data relative to the barrel,
collecting second data by the user terminal operating in a second operating mode, the second data being data relative to the collection of barrels, and
transmitting data to the data management platform, the transmission step including transmitting second data by the user terminal operating in the first operating mode to the data management platform.

2. The method according to claim 1, wherein the monitoring apparatus comprises at least one sensor able to perform a measurement relative to the barrel, at least one datum from among the first data and the second data being a measurement coming from a sensor.

3. The method according to claim 1, wherein the method includes a step for carrying out a statistical analysis on the transmitted data, the analysis step being carried out by the data management platform.

4. The method according to claim 1, wherein in the collection step, at least a second datum is obtained by reading one of the first data.

5. The method according to claim 1, wherein in the collection step, at least a second datum is separate from the first data.

6. The method according to claim 1, wherein the second data comprise the first data and additional data.

7. The method according to claim 1, wherein the method further includes a step for determining the barrel whose content is to be tasted including the calculation, for each barrel, of a tasting score of the content of the considered barrel as a function of the transmitted data.

8. The method according to claim 1, wherein the method further includes a step for comparing transmitted data to reference data and an alert step when transmitted data are missing or when transmitted data are too far from reference data.

9. The method according to claim 1, wherein at least one datum from among the first data and the second data is a datum relative to the ageing of the content of a barrel, the winemaking process of the content of a barrel, or the development of the content of a barrel, for example a datum relative to the sulfiting, the packing, the ullage or the clarifying of the content of a barrel.

10. The method according to claim 1, wherein at least one barrel comprises a wall having an inner face and an outer face, the wall defining an inner volume of said barrel comprised between the inner face and the outer face, a first electronic module being located in the inner volume comprised between the inner face and the outer face of the barrel and a second electronic module being affixed on the outer face of the barrel.

11. The method according to claim 1, wherein at least one datum from among the first data and the second data is a measurement done on the barrel or on the content of the barrel, in particular a measurement relative to the pressure, the temperature or the dioxygen concentration of the content of the barrel.

12. The method according to claim 1, wherein, during the collection step, the user terminal reads data coming from another marker.

13. The method according to claim 1, wherein, during the collection step, the user terminal reads data relative to elements necessary to develop the content of the barrel, in particular gas, proteins or inputs.

14. The method according to claim 1, wherein at least one datum from among the first data and the second data is a datum relative to the lot number of the content of a barrel, the method furthermore including a step for determining barrels comprising a content with the same lot number.

15. An apparatus for monitoring a collection of barrels, the monitoring apparatus comprising:
for each barrel, at least one electronic module being specific to the considered barrel, the electronic module comprising a memory capable of storing first data, the first data being data relative to the barrel, and
a user terminal, the user terminal being a mobile terminal capable of operating according to a first operating mode and a second operating mode, the user terminal being able to communicate with a data management platform in the first operating mode and not communicating with the data management platform in the second operating mode, the user terminal further being provided with at least one wireless communication reader operating in both operating modes, the user terminal being able to collect second data in the second operating mode, the second data being data relative to the collection of barrels, and to send the second data by the user terminal operating in the first operating mode to the data management platform.

16. The apparatus for monitoring a collection of barrels according to claim 15, comprising at least one sensor able to perform a measurement relative to the barrel, at least one datum from among the first data and the second data being a measurement coming from a sensor.
